(19) United States
(12) Patent Application Publication
(10) Pub. No.: US 2008/0177870 A1
(43) Pub. Date: Jul. 24, 2008

(54) SELECTING INFORMATION FOR AD HOC EXCHANGE

(75) Inventors: Douglas W. McDavid, Elk Grove, CA (US); Hovey R. Strong, San Jose, CA (US)

Correspondence Address: CANTOR COLBURN, LLP - IBM ARC DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/056,341

(22) Filed: Mar. 27, 2008

Related U.S. Application Data
(63) Continuation of application No. 11/615,176, filed on Dec. 22, 2006.

(51) Int. Cl. G06F 15/177

(52) U.S. Cl. 709/220

(57) ABSTRACT

A method for organizing an exchange of information between software agents includes for each of the software agents: establishing a semantic information network; receiving a trigger signal; performing a search of the semantic information network; and performing actions related to the trigger signal. A system and a computer program product for implementing the method are provided.

### CROSS REFERENCE TO RELATED APPLICATION

This application is filed under 37 CFR § 1.53(b) as a continuation application and claims priority under 35 U.S.C. §120 to U.S. patent application Ser. No. 11/615,176, filed Dec. 22, 2006.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to a computerized exchange of information.

2. Description of the Related Art

Communication devices with software programming may be used to communicate with similar communication devices over an ad hoc communications network. The communication devices include software agents. The communication devices may be mobile or stationary. Typically, the majority of the communication devices are mobile. One example of a mobile communication device is a wireless personal digital assistant (PDA). Some the software agents may operate under some form of centralized control. The centralized control is provided by a central controller. Some of the software agents may operate autonomously (i.e., without the centralized control).

Instances may occur when communications with the central controller are impeded. Impediment may be due to several reasons. One reason is a disaster recovery operation. Communications between the central controller and the software agents may be disrupted during the disaster recovery operation. Another reason may be due to the central controller being overwhelmed with traffic. For example, the central controller may not communicate with the software agents when massive amounts of data distribution exceed the capacity limitations of the central controller.

When communications between the software agents and the central controller are impeded, the software agents may still communicate with other software agents. The software agents may still communicate with each other because of proximity to each other or because of some other temporal communications availability. With no centralized control, the software agents communicate with each other as peers. Even when the software agents operate under the control of the central controller, there are many occasions when the software agents communicate with each other as peers.

In the ad hoc communications network, the software agents may be tasked with solving parts of a data distribution problem. The software agents may also communicate with each other to increase the efficiency of accomplishing assigned tasks. Without some form of organization, the software agents may limit the amount of data communicated due to communication time and capacity limitations. Additionally, communications between the software agents may be impeded if the software agents have different data organizations. There are many types of data organizations. For example, some of the software agents may organize data in a relational database. Other software agents may organize data in a hierarchy or in a general semantic network. Impeded communications may jeopardize accomplishing the assigned tasks of the software agents.

What are needed are software and hardware to organize the exchange of information between the software agents when the software agents communicate in the ad hoc communications network.

### SUMMARY OF THE INVENTION

The shortcomings of the prior art are overcome and additional advantages are provided through a method for organizing the exchange of information between software agents, the method for each software agent includes establishing a semantic information network; receiving a trigger signal; performing a search of the semantic information network; and performing actions related to the trigger signal.

Also disclosed is a system for organizing the exchange of information between software agents, the system includes an ad hoc communications network for communicating between a plurality of communication devices; and the plurality of communication devices, the plurality of communication devices comprising the software agents for establishing an information database in each of the software agents, receiving a trigger signal, searching the information database in each of the software agents, and performing actions related to the trigger signal.

Further disclosed is a computer program product stored on machine readable media, the product providing instructions for organizing the exchange of information between software agents, the instructions for each software agent include instructions for receiving a universal network schema for establishing a semantic information network; establishing the semantic information network; receiving at least one of a message from another software agent and a notice of impeded communications with a central controller as a trigger signal; performing a modified depth first search of the semantic information network; and sending an XML data file with at least one of a begin tag and an end tag to at least one other software agent.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution in which a computer program product stored on machine readable media includes machine readable instructions for organizing the exchange of information between software agents, the instructions for each software agent include instructions for receiving a universal network schema for establishing a semantic information network; establishing the semantic information network; receiving at least one of a message from another software agent and a notice of impeded communications with a central controller as a trigger signal; performing a modified depth first search of the semantic information network; and sending an XML data file with at least one of a begin tag and an end tag to at least one other software agent.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of an ad hoc communications network;

FIG. 2 depicts aspects of a semantic information network; and

FIG. 3 illustrates an exemplary method for organizing information exchanges between software agents.

The detailed description explains the preferred embodiments of the invention, together with advantages and features, by way of example with reference to the drawings.

### DETAILED DESCRIPTION OF THE INVENTION

The teachings herein provide for organizing information exchanges between software agents in an ad hoc communications network. A first ad hoc exchange of information between two software agents is referred to as an “initial exchange.” The teachings provide for selecting information to be exchanged between the two software agents during the initial exchange. The selecting limits the amount of information to be exchanged. Without limiting the amount of information exchanged, the software agents could become communications bottlenecks. The software agents can determine whether more information exchanges are warranted using the information from the initial exchange. Additionally, the software agents can determine whether to undertake further coordinated action. Before the teachings are discussed in detail below, certain definitions are provided.

The term “ad hoc communications network” relates to a communications network built for a specific purpose. Typically, the communication devices within the ad hoc communications network are mobile. The communication devices within the ad hoc communications network have the capability of discovering and communicating with other communication devices. Discovered communication devices may then be added to the ad hoc communications network. The term “XML” relates a computer language known as “extensible markup language.” The primary purpose of XML is to facilitate the sharing of data files across different information systems. Organization of an XML data file is hierarchical.

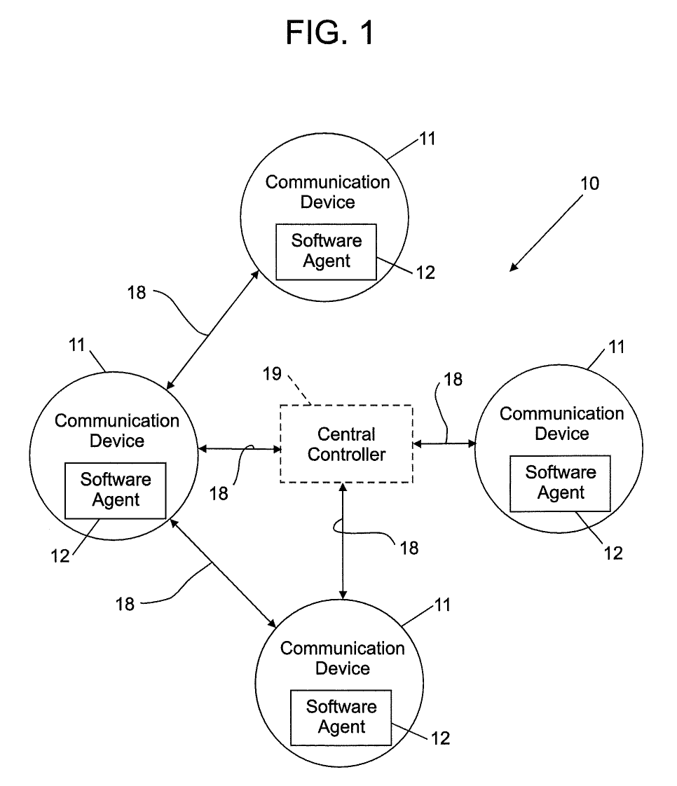

FIG. 1 illustrates one example of an ad hoc communications network 10. The ad hoc communications network 10 includes a plurality of communication devices 11. Each of the communication devices 11 includes a software agent 12. The communication devices 11 communicate via communication links 18. The communication links 18 may be at least one of wireless, Internet, and hard wire. FIG. 1 represents one instant of the ad hoc communications network 10. The ad hoc communications network 10 will change as the communication links 18 are lost and made. Additionally, a central controller 19 may provide some form of centralized control. In some embodiments, the ad hoc communications network 10 may not have a central controller 19. While some embodiments may have the central controller 19, the central controller 19 is not required for the ad hoc communications network 10 to function.

A universal network schema provides for organizing information within each of the software agents 12. In some embodiments with the central controller 19, the central controller 19 maintains a current version of the universal network schema. The central controller 19 downloads the current version of the universal network schema to each of the software agents 12. Alternatively, the universal network schema may be pre-specified for each of the software agents 12.

The communication devices 11 communicate with other communication devices 11 and the central controller 19. Communications may be one of voice, video, and data. Examples of the communication devices 11 include a mobile station, a fixed station, a cellular phone, a satellite phone, and the wireless PDA. In general, each of the communication devices 11 has software programs. The software programs provide for downloading information from the central controller 19 and other communication devices 11. The software programs also provide for maintaining an information database.

The software agent 12 is a software program that acts on behalf of other software programs in the communication device 11. The acting is a form of an agency relationship. Each of the software agents 12 maintains at least part of the information database in each of the communication devices 11. Typically, the information database is one of three data models—network, hierarchal, and relational. Each of the data models is capable of representing the other data models.

Each of the software agents 12 maintains information about itself. The information includes a current mission and capabilities. The software agent 12 also maintains information about at least some of the other software agents 12. However, any one software agent 12 may not have information about all the other software agents 12.

The software agent 12 updates the information about the other software agents 12 by communicating with the other software agents 12. Typically, the information exchanged is in the form of an XML data file.

Techniques are provided to select information for the initial exchange. The techniques provide for organizing the information within the software agents 12. The organizing is provided by the universal network schema. The universal network schema may be controlled by the central controller 19 (when present) in order to maintain consistency. The software agents 12 provide for sending the current version of the universal network schema to the other software agents 12. The universal network schema provides for implementing a semantic information network. All of the data models can be associated into the semantic information network.

The term “semantic information network” relates to a form of knowledge representation. The knowledge representation relates to a directed graph. The directed graph includes labeled nodes and edges. The nodes represent types of data and the edges represent semantic relationships between the types of data. Any of the data models may be native to the software agents 12.

The directed graph is a convenient way of viewing any of the data models. Both hierarchical and relational data models typically represent network data models via keys, pointers, and attributes. It is rare to find a useful relational database without any pointer represented relationships between tables. The network data model is the most general and simplest. The initial exchange information may be selected from at least one of hierarchical and relational data models but the intuition always reverts back to the network data model. In general, the universal network schema imposes the semantic information network in each software agent 12.

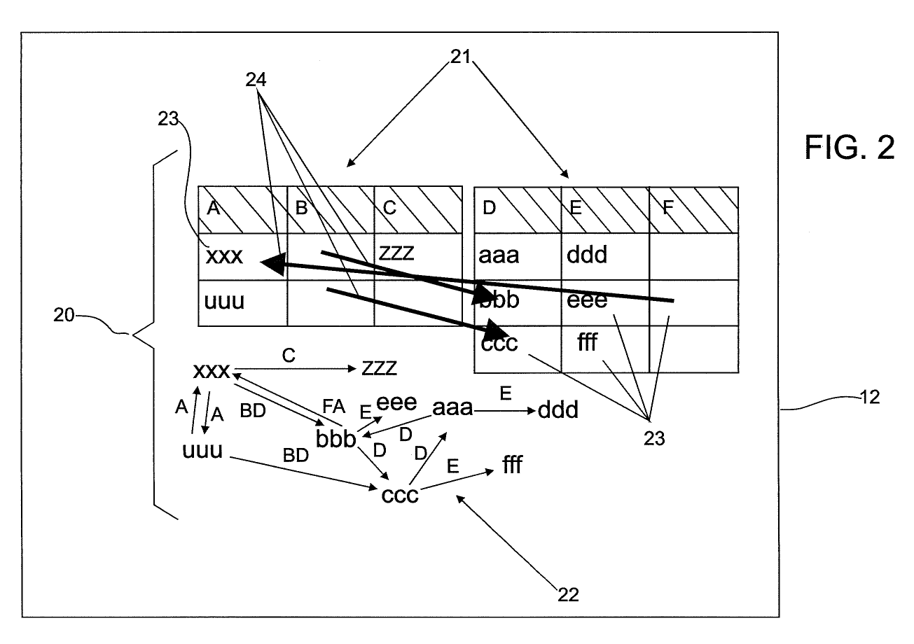

FIG. 2 presents one example of imposing the semantic information network using the universal network schema. The semantic information network is imposed upon one software agent 12. Referring to FIG. 2, the data model native for the software agent 12 is a relational database 21. A universal network schema 20 transforms the relational database 21 into a semantic information network 22. Nodes of the semantic information network 22 include data 23 from the relational database 21. Edges of the semantic information network 22 include relations 24 between the data 23 from the relational database 21. The techniques provide for selecting information for the initial exchange from the semantic information network 22.

The initial exchange includes two types of information. One type of information includes the current version of the universal network schema. The other type of information includes information extracted from the semantic information network 22 based upon the techniques herein.

The techniques provide for a biased and constrained depth first search of the semantic information network 22. A result of the biased and constrained depth first search is a hierarchically organized subset of the information in the semantic information network 22. The information extracted from the biased and constrained depth first search is suitable for transmission (typically, an XML data file) via the communication links 18.

A biased depth first search includes a specific ordering of at least one edge label that the search may traverse. For example, a bias may be set for following the edges labeled “mission” first. By selecting the bias toward mission oriented information, the biased depth first search can explore the information relevant to determining two factors. The first factor is whether more information is needed from future exchanges. The second factor is whether missions of the two software agents 12 are compatible. Compatible missions may provide for taking coordinated actions. For example, if two communication devices 11 have a same mission, then the two communication devices 11 may share resources such as storage in support of the mission.

A constrained depth first search includes two limits. A first limit includes the number of times the search will visit a node of a specific type. A second limit includes the number of times the search will traverse an edge of a specific type. The constrained depth first search will include at least one of the limits for each specific type of information relevant to the search. The constrained depth first search will extract information relevant to the search without extracting the entire semantic information network 22. The biased and constrained depth first search is also referred to as a “modified depth first search.”

In another form of the biased and constrained depth first search, there is no limit to the number of times a node is visited. This type of search is referred to as a “depth first search with bias and partial constraint.”

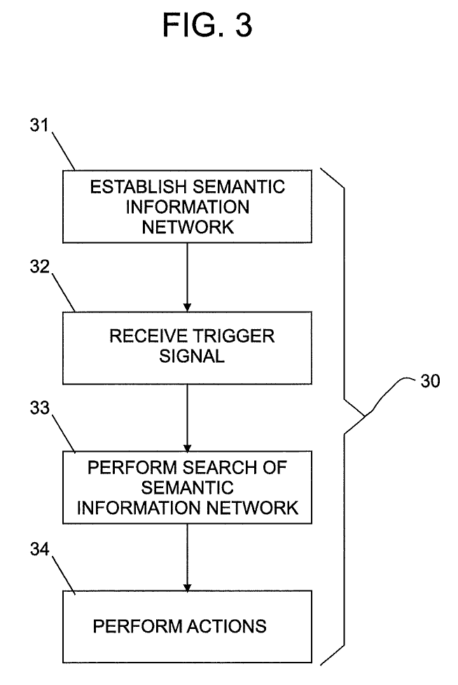

FIG. 3 illustrates an exemplary method of organizing information exchanges between the software agents 12. The organizing method 30 of FIG. 3 includes four steps. A first step 31 includes establishing the semantic information network 22 in each of the software agents 12. The first step 31 may also include receiving the universal network schema. A second step 32 includes the software agent 12 receiving a trigger signal. The trigger signal may be at least one of a notice of impeded communications with the central controller 19 and a first message from another software agent 12. A third step 33 includes performing a search of the semantic information network 22 in the software agent 12. The search may be at least one of the modified depth first search and the depth first search with bias and partial constraint. Typically, the search is related to the mission of the software agent 12. A fourth step 34 includes performing actions. In general, the actions may include sending a second message with content related to the search to at least one other software agent 12. The second message may also include the current version of the universal network schema 20. Typically, the second message is related to the mission of the software agent 12. The second message may be an XML data file. The actions may also include performing tasks related to the first message. The tasks may include coordinated actions between at least two software agents 12.

The message sent from one software agent 12 to another software agent 12 typically contains information related to the search of the semantic information network 22. Information related to how the search was conducted can be inserted in the message. The information may include a begin tag and an end tag. The begin tag may include content of a label of each edge traversed for a first time. The end tag may include the label of each edge traversed for a last time.

In the relational database, the modified depth first search may be described as a depth first search over implicit links determined by entries in a catalog. A structured query language (SQL) query of the relational database may be used. However, the SQL query corresponding to the modified depth first search is quite complex. In the XML data file, the modified depth first search may be described as the depth first search over the implicit links determined by attributes as well as over links in an explicit hierarchy. A native network data model may have performance advantages in execution of the modified depth first search but other mission oriented constraints may give preference to one of the other data models.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for organizing an exchange of information between software agents, the method for each software agent comprising:
establishing a semantic information network;
receiving a trigger signal;
performing a search of the semantic information network; and
performing actions related to the trigger signal.

2. The method as in claim 1, wherein the establishing comprises receiving a universal network schema.

3. The method as in claim 1, wherein the receiving comprises receiving notice of impeded communications with a central controller.

4. The method as in claim 1, wherein the receiving comprises receiving a message from another software agent.

5. The method as in claim 1, wherein the performing a search comprises performing a modified depth first search.

6. The method as in claim 1, wherein the performing a search comprises performing a depth first search with bias and partial constraint.

7. The method as in claim 1, wherein the performing actions comprises sending a message to at least one other software agent.

8. The method as in claim 7, wherein the sending a message comprises sending the message with at least one of a begin tag and an end tag.

9. The method as in claim 7, wherein the sending a message comprises sending an XML data file.

10. The method as in claim 1, wherein the performing actions comprises performing coordinated actions with at least one other software agent.

11. A system for organizing the exchange of information between software agents, the system comprising:
an ad hoc communications network for communicating between a plurality of communication devices; and
the plurality of communication devices, the plurality of communication devices comprising the software agents for establishing an information database in each of the software agents, receiving a trigger signal, searching the information database in each of the software agents, and performing actions related to the trigger signal.

12. The system as in claim 11, further comprising a central controller for controlling a universal network schema.

13. The system as in claim 11, wherein the plurality of communication devices comprises at least one of a mobile station, a fixed station, a cellular phone, a satellite phone, and a wireless personal digital assistant.

14. The system as in claim 11, wherein the information database comprises a semantic information network.

15. The system as in claim 11, wherein the trigger signal comprises a message.

16. The system as in claim 11, wherein the trigger signal comprises a notice of impeded communications with a central controller.
